(19) United States
(12) Patent Application Publication
(10) Pub. No.: US 2002/0032006 A1
(43) Pub. Date: Mar. 14, 2002

(54) Efficient network routing method for air/ground data services

(76) Inventors: K. Prasad Nair, Bethesda, MD (US); Steven Friedman, Silver Spring, MD (US)

Correspondence Address: BLANK ROME COMISKY & MCCAULEY LLP, THE FARRAGUT BUILDING SUITE 1000, 900 17TH STREET NW, WASHINGTON, DC, 20006, US

(21) Appl. No.: 09/848,552

(22) Filed: May 4, 2001

Related U.S. Application Data
(60) Provisional application No. 60/202,119, filed on May 5, 2000.

(51) Int. Cl. H04B 7/00

(52) U.S. Cl. 455/66; 455/445

(57) ABSTRACT

A networking architecture for air/ground data communications which implements a single network-layer protocol between a customer aircraft network interface and a customer ground system network interface, which routes data between customer aircraft and associated customer ground systems, and which eliminates the need for network-layer protocol conversion by service provider ground systems.

### REFERENCE TO RELATED APPLICATION

The present application claims the benefit of U.S. Provisional application No. 60/202,119, filed May 5, 2000, whose disclosure is hereby incorporated by reference in its entirety into the present disclosure.

### FIELD OF THE INVENTION

The present invention is directed to the processing and routing of air/ground data communications between aircraft and ground systems.

### BACKGROUND OF THE INVENTION

Commercial aircraft commonly transmit and receive air/ground digital information via radio equipment operating in the Very High Frequency (VHF) portion of the radio spectrum, on 25 kHz channels, using a system known generically as the Aircraft Communications Addressing and Reporting System (ACARS). There are several variations of ACARS in use today, including extensions to satellite relay media and High Frequency (HF) radio. Communications services using these systems are provided to customers by commercial enterprises on a for-fee basis, using networks of fixed ground stations (and optionally satellites) which support compatible protocols and hardware. The airborne equipment, ground station equipment and extended ground network all cooperate to support the end-to-end transmission and reception of digital information between a customer's aeronautical mobile station (an aircraft) and ground-based end-system (e.g., an airline operations center). In the currently-deployed and operational systems, onboard end-system equipment (e.g., an FMC or printer) communicates individually with an ACARS Management Unit (MU) according to the rules of ARINC Specification 619. The ACARS MU acts as an application gateway between these onboard systems and the air/ground network which includes the RF link and extends to a service-provider application gateway. The ground/ground data exchange between a service-provider application gateway and a customer-premises application gateway is viewed as comprising a separate network with different and incompatible protocols relative to the air/ground network. It is the responsibility of the service provider to manage the air/ground exchange of data and provide routing and protocol conversions as needed to interface with the intended users' ground-based end-systems. The ACARS air/ground environment is described in ARINC Specification 618. The capabilities of onboard equipment are defined in ARINC Characteristics 597, 724 and 724B. The ACARS ground/ground environment is described in ARINC Specification 620. The routing and protocol conversion functions are provided in one or more application gateway(s) maintained by the service provider(s). The(se) application gateway(s) represent critical points of failure, and must be highly reliable in order to ensure the desired quality of service.

In the currently-deployed and operational systems, both the air/ground protocol (e.g., ARINC 618) and the ground/ground protocol (e.g., ARINC 620) require significant tailoring on a per-customer basis (i.e., some messages are airline-specific and so must be interpreted differently for each airline), a per-aircraft basis (different aircraft operated by the same airline may support different equipment which requires special protocol conversions on the air or on the ground), and sometimes even a location basis (some destination addresses must be decoded differently based on the current location of the aircraft). This leads to a complex service provider application gateway. Therefore, another consequence of the present system is ongoing protocol configuration tailoring which in turn leads to high maintenance cost, impaired network performance (many failures are attributed to software error) and impaired network robustness (due to the criticality of the centralized conversion).

The aviation community has developed a new networking standard, known as the Aeronautical Telecommunications Network (ATN), which replaces the entire current system with new avionics and ground equipment providing end-to-end routing without need for protocol conversion by the service provider. This enhances ground network reliability but requires all new hardware on customer aircraft and at customer ground sites. The transition, from the current system architecture comprising two incompatible networks to the future system architecture comprising a single end-to-end network, is planned to occur in several stages comprising, among others,

a) transition to a new air/ground radio subnetwork with higher throughput than is currently available (but the air/ground network protocols will remain substantially unchanged);

b) service providers will install appropriate ground equipment and networks to support the ATN, operating in parallel with existing services; and

c) eventually, the application gateways on customer aircraft and at customer-premises ground facilities will be replaced or modified to support the ATN.

The problem of communicating information across incompatible networks is well-known in the prior art. Yanosy, Jr., et. al. (U.S. Pat. No. 4,677,611) discloses a method for executing communication protocol conversions among a plurality of protocols, thereby allowing data communications among devices operating on incompatible networks, by converting all protocols to a common uniform protocol. Homey, II, et. al. (U.S. Pat. No. 5,581,558) discloses a bridging apparatus which facilitates communication between processors across networks having incompatible protocols, the bridging apparatus comprising a LAN/WAN bridge with packet assembly/disassembly and bridging functionality. Wiedeman (U.S. Pat. No. 5,640,386) discloses a method for bidirectionally coupling a first satellite communication system to a second satellite communication system, using a ground-based protocol conversion unit. Kulkarni, et. al. (U.S. Pat. No. 5,862,481) discloses an inter-technology roaming proxy which has elements in the mobile equipment and the fixed ground equipment. This system relies on coordination between the two incompatible systems. Gallagher, et. al. (U.S. Pat. No. 5,933,784) also discloses a signaling gateway and method for two incompatible cellular systems which relies in part on communications between the two systems. Alexander, Jr., et. al. (U.S. Pat. No. 5,946,311) discloses a method for allowing more efficient communication in an environment wherein multiple protocols are utilized, essentially by overlaying a base protocol with additional protocols. Brivet, et. al. (U.S. Pat. No. 6,011,842) discloses a telecommunications network with heterogeneous operation codings, essentially comprising a network node which allows compatible communications to pass in a transparent manner, and which appropriately changes the format of incompatible messages so that they may be handled by the remainder of the network. Vo, et. al. (U.S. Pat. No. 6,044,274) discloses a method for handling of mobile originated intelligent network calls from a non-intelligent capable mobile switching center.

In FIG. 1, the current air/ground networking architecture is illustrated. Consider a downlink message i.e. one generated by an aircraft 11 intended for delivery to a customer-premise end system 20 on the ground. The message may be generated with our without human intervention by onboard equipment 12 or the application gateway 13, for example an ACARS MU. The aircraft application gateway 13 is part of the air/ground communications network 15 which typically implements a standardized set of protocols tailored for RF communications between the airborne radio equipment 14 and the ground station radio equipment 16. The set of protocols would typically comprise physical, link layer and subnetwork layer protocols for RF communications between airborne radio 14 and ground radio 16, and network layer protocols for data communications between the airborne application gateway 13 and the service provider's application gateway 17. The network access points for the air/ground network 15 are the airborne application gateway 13 and the service provider's application gateway 17. One example of a network layer protocol is the ARINC Specification 618 which implements ACARS.

The user's message information is passed through the radio equipment 14, the ground station 16, and thence to the service provider's application gateway 17, for example AFEPS in the ARINC ACARS network. The detailed formatting of the message may depend on aircraft ID and ground station location, as noted above, but must conform with the protocol standard for the air/ground network as a whole (for example, ARINC Specification 618). Several message interchanges may exist between each pair of hardware elements, and the path between the ground station 16 and the application gateway 17 may traverse many networking nodes, but the important feature is that information encoded in the air/ground networking protocol standard (e.g., ARINC Specification 618) is only decoded and processed at the application gateway 17.

After reading the downlink message and understanding its source and intended destination, the application gateway 17 reformats the message to comply with a separate ground/ground networking protocol (for example, ARINC Specification 620) and delivers the message through a ground/ground network 18 to the intended destination customer premises application gateway 19 (which may then pass the information to other customer equipment 20). Again, the path from the service provider's application gateway 17 to the customer premises application gateway 19 could traverse many networking nodes and several messages may be exchanged on each leg of the path. The network access points for the ground/ground network 18 are the service provider's application gateway 17 and the customer premises application gateway 19.

Uplink information passes from ground-based customer equipment to an aircraft by following a path substantially in reverse order to that described for a downlink message.

The principle feature of the present system is that an application gateway provides the interface between the air/ground network 15 and the ground/ground network 18. The service provider's application gateway cannot be bypassed since, for example, the source and destination information used on the air/ground network 15 is not able to be interpreted by the protocol elements of the ground/ground network 18.

The ATN provides a single network without any need for the service provider to maintain an application gateway, but requires the replacement of the airborne application gateway 13 and the customer premises application gateway 19.

### SUMMARY OF THE INVENTION

This invention is a network architecture for air/ground data communications which reuses currently-deployed and operational equipment while eliminating the need for application gateway(s) maintained by service provider(s) on the ground. Specifically, this invention comprises a new application gateway on the aircraft which allows a) the deletion of the application gateway maintained by the service provider on the ground, and also allows b) the reuse of existing onboard application gateways and customer premises application gateways. This invention treats the data path between a customer aircraft and a customer ground-based end-system as contained within a single network, similar to the concept of the ATN, but does not require the replacement of existing application gateway equipment onboard customer aircraft or at customer premises facilities on the ground. The invention offers the following benefits:

(a) The centralized architecture used today, with high workload and high reliability requirements on the service provider's protocol conversion system, is replaced with a distributed architecture where necessary protocol conversions are performed on customer aircraft and at customer premises on the ground. By distributing the protocol conversion task to numerous customer nodes, the individual workload at each node is reduced to a degree which allows the customer-specific functions to be supported in a mobile device, and overall network reliability can be enhanced (i.e., since a critical point of failure represented by the service provider's application gateway is eliminated) (the service provider's communications network and routing system should still maintain high reliability);

(b) The service provider's data processing systems need not read the payload of each message (i.e., since the service provider role is only network communications and routing as opposed to an application gateway). This enhances reliability since a) most outages in the present system are due to software crashes and upgrades, which can be minimized since service provider functionality is reduced and b) the network can route around failed nodes. Customer data security is also enhanced since the payload is not read by the service provider (and can therefore be encrypted with keys maintained by the customer alone);

(c) Increased customer flexibility since the configuration tables are maintained by the customer, can be updated at will without dependence on human workload scheduling by the service provider, and do not affect other users.

(d) Ease of transition, and reduced user cost relative to implementation of ATN, since existing avionics and ground equipment can be reused.

The present invention is distinguished from the prior art in the following respects: a) it relates to an aeronautical mobile networking environment as opposed to fixed wireline, terrestrial cellular or satellite-based mobile communications; b) the two incompatible networks are already bridged—the improvement of the present invention is achieved by effectively moving the network access point for the ground/ground network into each participating mobile station (i.e., by replicating, at numerous mobile stations, certain functions of a pre-existing fixed ground-based application gateway currently maintained by a service provider, each set of replicated functions tailored to a particular customer, thereby allowing communications to fully bypass said pre-existing fixed ground-based application gateway and associated networking facilities. Prior systems tailored to mobile communications include features in the ground infrastructure as well as the mobile stations); c) the present invention is also distinguished from the prior art, and current operational practice in the field of aeronautical data communications and networking, in that the responsibility for protocol enhancements can be shifted to the customers and away from the network service provider.

### BRIEF DESCRIPTION OF DRAWINGS

FIG. 1 illustrates a conceptual view of the existing air/ground network architecture.

FIG. 2 illustrates a conceptual view of the improved architecture according to the present invention.

### DETAILED DESCRIPTION OF THE INVENTION

A preferred embodiment of the present invention will be set forth with reference to FIG. 2.

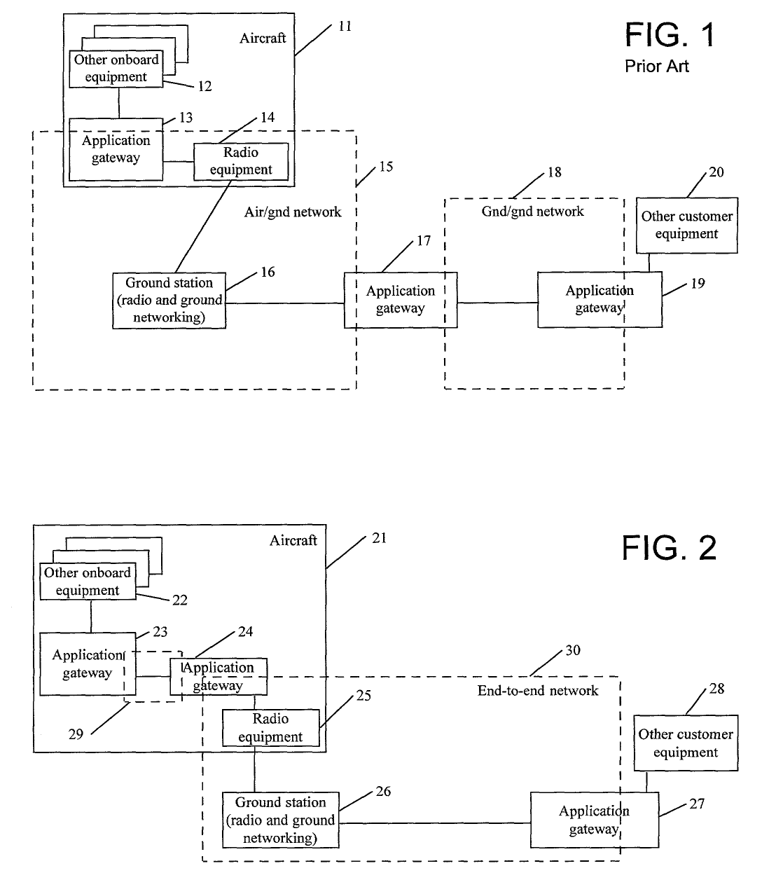

FIG. 2 illustrates an alternative network architecture according to the preferred embodiment, wherein the service provider's application gateway 17 is eliminated and the ground/ground network 18 is expanded to become an end-to-end network 30 comprising selected aircraft avionics as well as ground stations 26, internetworking facilities (not shown) and customer premises application gateway(s) 27. The aircraft equipment includes a legacy application gateway 23 which may be the same as the present system application gateway 13 illustrated in FIG. 1, and a new additional application gateway 24 which comprises the functions of customer-specific protocol conversion and routing functionality for the end-to-end network 30. The onboard radio 25 and ground station 26 may be legacy systems or new systems, or may comprise a mixture of new and old systems. Since the new application gateway 24 must interoperate with the old application gateway 23, a necessary feature of this architecture is that the air/ground network of the present system may be considered to exist in a virtual sense as the network 29 comprising selected protocol elements in the legacy application gateway 23, the new application gateway 24, and the signal path(s) between them.

Since the new application gateway 24 is intended to support data communications for a single aircraft, processing load is low and software complexity is low. Therefore, in a preferred embodiment the functionality of the new application gateway 24 may be incorporated in the same chassis that houses the (new) radio equipment 25.

A downlink message is originated in an aircraft 21 either by onboard equipment 22 or the legacy application gateway 23 (messages may also be originated by the new application gateway 24, but the procedure for handling these messages is obvious and will not be described). In FIG. 2 the legacy application gateway 23 supports only the protocol defined by ARINC Specification 618, so in this case the new application gateway 24 converts the message from an ARINC 618 format to a different format tailored to the end-to-end network 30. An example of such a format is ARINC Specification 620 (possibly compressed using a standard stream compression algorithm) over TCP/IP, allowing direct communication with the customer premises application gateway 27 using industry-standard network protocols.

Downlink information is passed from the new application gateway 24 (if present) to the radio equipment 25, thence to a ground station 26 over an RF communications link, and thence to customer premises application gateway 27 over a ground network that can comprise numerous nodes (not shown). The customer premises application gateway 27 interprets the message and passes it as required to other customer equipment 28.

As in the present system, each link between pairs of hardware elements may operate with different physical, link layer and subnetwork layer protocols. For example, in the preferred embodiment of the present invention, the RF link between airborne radio equipment 25 and ground station 26 relies on physical, link layer and subnetwork layer protocols defined by draft ICAO-standard VHF Data Link Mode 4.

Since the new application gateway 24 emulates the behavior of the service provider's application gateway 17 as perceived by the old application gateway 23, messages may be delivered from the old application gateway 23 to the new application gateway 24 and held for later delivery, for example if a suitable end-to-end network path is not immediately available. So another feature of the present invention is an enhanced store-and-forward capability (the application gateway may already support store-and-forward capability catering to times when the e.g. ACARS air/ground network is not available. The enhanced store-and-forward capability disclosed here additionally allows storage when an e.g. ACARS air/ground network is available but a new end-to-end network is not available).

Uplink information passes from ground-based customer equipment 28 to an aircraft 21 by following a path substantially in reverse order to that described for a downlink message.

A variation of the present invention is to alter the legacy application gateway 23 so that it supports the end-to-end network protocol directly. In this case the new application gateway 24 may be deleted, the legacy application gateway 23 (modified or replaced) communicates directly with the radio equipment 24, and the end-to-end network 30 encompasses portions of the modified or replaced legacy application gateway 23 functionality. In this case the air/ground network 29 of the existing system does not exist on the aircraft even as a virtual element.

One advantage of the present invention is that the application gateway 17 of FIG. 1, between air/ground and ground/ground networks, is eliminated from the ground-based networking architecture. The application gateway may be considered to exist in virtual sense onboard each aircraft, e.g. in the protocol bridge 24 of FIG. 2 or a redesigned/replaced airborne application gateway 23. However, by eliminating the application gateway from the ground networking architecture, data processing workload on the service provider's network is reduced and a critical point of failure is removed. The cost of maintaining a highly reliable application gateway is avoided, and overall system availability is expected to improve. Hardware elements can fail on individual aircraft and at individual customer premises, but these failures do not compromise overall network availability for other users.

A second advantage of the present invention is that information can be routed between ground stations and customer sites over any available path (e.g., the internet).

A third advantage of the present invention is that individual users may tailor their messages independently of one another and independently of the network service provider, and the tailoring can change as the configuration of the aircraft changes. This avoids errors due to unintentional user-to-user ambiguity, eliminates delays associated with service provider workload scheduling, and provides increased user flexibility. A customer can also update the configuration remotely without requiring that the aircraft be taken out of service for equipment removal and replacement.

A fourth advantage of the present invention is that users may upgrade their services incrementally, switching to a new network service provider (with a new application gateway 24, and possibly a new radio 25 which may be housed in the same chassis), while reusing existing avionics such as an ACARS MU. At a later stage, the existing ACARS MU can be modified or replaced and the functionality of the new application gateway 24 adjusted appropriately.

A fifth advantage of the present invention is an enhanced store-and-forward capability.

A sixth advantage of the present invention is an improvement in delivery guarantees since a delivery acknowledgement via the single end-to-end network has greater significance than a delivery acknowledgement via the present system air/ground network alone, and since various end-to-end requirements can be satisfied in a manner that con only be emulated with the legacy application gateways.

A seventh advantage of the present invention is the potential for customer encryption independent of the service provider.

While various preferred embodiments of the present invention have been set forth above, those skilled in the art who have reviewed the present disclosure will readily appreciate that other embodiments can be realized within the scope of the invention. For example, protocols other than those specifically set forth above can be implemented. Therefore, the present invention should be construed as limited only by the appended claims.

We claim:

1. An end-to-end network for air/ground data communications between a customer aircraft and a customer ground facility, the network comprising:
on the aircraft, a first radio for communicating with the end-to-end network and an application gateway for connecting the first radio with other equipment on the aircraft by network protocol conversion; and
on the ground, a second radio for communicating with the first radio and a ground network for transmitting the data communications between the second radio and the customer ground facility,
wherein the data communications among the first radio, the second radio and the ground network use a common network protocol so that network-layer protocol conversions between the aircraft and the ground network are not required.

2. The end-to-end network of claim 1, wherein some or all of the ground network is a part of the worldwide Internet.

3. The end-to-end network of claim 1, wherein the ground network uses network control and routing protocols which are interoperable with the worldwide Internet.

4. The end-to-end network of claim 1, wherein the ground network uses network control and routing protocols which are interoperable with the Aeronautical Telecommunications Network (ATN).

5. An end-to-end network for air/ground data communications between customer aircraft and customer ground facilities, the end-to-end network comprising:
on the aircraft, first and second application gateways representing first and second network interface points of a network supporting a legacy air/ground networking protocol, and one network interface point for a network supporting a legacy ground/ground networking protocol; and
on the ground, a radio for communicating with the aircraft and a ground network supporting the legacy ground/ground networking protocol;
wherein the second application gateway and the network interface point jointly support all customer-relevant protocol conversions and processing required to provide internetworking between a) the legacy air/ground networking protocol and the legacy ground/ground networking protocol, thereby allowing bypass of a service-provider application gateway on the ground.

6. The end-to-end network of claim 5, wherein some or all of the ground network is a part of the worldwide Internet.

7. The end-to-end network of claim 5, wherein the legacy ground/ground networking protocol is interoperable with the worldwide Internet.

8. The end-to-end network of claim 5, wherein the legacy ground/ground networking protocol is interoperable with the Aeronautical Telecommunications Network (ATN).

9. The end-to-end network of claim 5, wherein at least one of the second application gateway and the network interface point implements a store-and-forward capability.

10. The end-to-end network of claim 5, wherein at least one of the first and second application gateways supports protocol configuration tailoring remotely.

11. The end-to-end network of claim 5, wherein user data is encrypted and passed transparently through the ground network without decryption in the ground network.
